(19) United States
(12) Patent Application Publication
(10) Pub. No.: US 2026/0099247 A1
(43) Pub. Date: Apr. 9, 2026

(54) METHOD FOR DISPLAYING AND ELECTRONIC DEVICE IMPLEMENTING SAME

(71) Applicant: Samsung Electronics Co., Ltd., Suwon-si (KR)

(72) Inventors: Dongkyun KANG, Suwon-si (KR); Sungwook JI, Suwon-si (KR); Yookyung HAM, Suwon-si (KR); Nagyeom YOO, Suwon-si (KR)

(21) Appl. No.: 19/416,601

(22) Filed: Dec. 11, 2025

Related U.S. Application Data
(63) Continuation of application No. PCT/KR2024/007555, filed on Jun. 3, 2024.

(30) Foreign Application Priority Data
Sep. 11, 2023 (KR) 10-2023-0120581
Jul. 20, 2023 (KR) 10-2023-0094514

(51) Int. Cl. G06F 3/0487; G06F 3/01; G06F 3/0482; G06F 3/0486

(52) U.S. Cl. CPC G06F 3/0487; G06F 3/013; G06F 3/0482; G06F 3/0486; G06F 2203/04803

(57) ABSTRACT

A display method may include: identifying tilt information about an electronic device detected through a sensor module of the electronic device; displaying an execution screen of a main task in a first area of a display of the electronic device on the basis of the tilt information, and arranging and displaying a control element, corresponding to the main task, in a second area which is at least a portion of the first area; and when the degree of tilt of the electronic device with respect to a reference direction as indicated by the tilt information changes by a threshold range, displaying the execution screen of the main task in the first area by rotating the execution screen according to a screen direction determined by the tilt information, and displaying the control element rearranged in the second area by rotating or relocating the control element.

### CROSS-REFERENCE TO RELATED APPLICATIONS

This application is a continuation application of International Application No. PCT/KR2024/007555, filed on June 3, 2024, in the Korean Intellectual Property Receiving Office, and claiming priority to KR Application No. 10-2023-0094514 filed July 20, 2023, and KR Application No. 10-2023-0120581 filed Sept. 11, 2023, the disclosures of which are all hereby incorporated by reference herein in their entireties.

### TECHNICAL FIELD

Certain example embodiments relate to a display method of an electronic device.

### BACKGROUND

An electronic device may include a notch area including a camera and various sensors disposed adjacent to a display or in a portion of the display. Due to the notch area, when some display area cannot be utilized, the electronic device may display various information such as battery status, cellular signal strength, Wi-Fi status, or time information in another portion of the display adjacent to the notch area. Various elements may be provided to maximize and/or improve utilization of the display screen and provide improved user experience.

### SUMMARY

An electronic device, according to an example embodiment, may include a display, a sensor module, at least one processor comprising processing circuitry, and a memory storing instructions, wherein the instructions, when executed individually and/or collectively by the at least one processor, may cause the electronic device to: identify tilt information of at least part of the electronic device detected through the sensor module, based on the tilt information, display an execution screen of a main task in a first area of the display, and display a control element corresponding to the main task in a second area which is at least a portion of the first area, and based on identifying a degree of tilt of at least part of the electronic device with respect to a reference direction indicated by the tilt information changing by at least a threshold range and/or amount, display the execution screen of the main task in the first area at least by rotating the execution screen of the main task according to a screen orientation determined based on the tilt information, and rearrange and display the control element in the second area at least by rotating and/or relocating the control element.

A display method, according to an example embodiment, performed by an electronic device, may include: an operation of identifying tilt information of at least part of the electronic device detected through a sensor module of the electronic device, an operation of, based on the tilt information, displaying an execution screen of a main task in a first area of a display of the electronic device, and displaying a control element corresponding to the main task in a second area which is at least a portion of the first area, and an operation of, based on identifying a degree of tilt of at least part of the electronic device with respect to a reference direction indicated by the tilt information changing by at least a threshold range and/or amount, displaying the execution screen of the main task in the first area at least by rotating the execution screen of the main task according to a screen orientation determined based on the tilt information, and rearranging and displaying the control element in the second area at least by rotating and/or relocating the control element.

An electronic device, according to an example embodiment, may include a display, a sensor module comprising at least one sensor, at least one processor comprising processing circuitry, and a memory storing instructions, wherein the instructions, when executed individually and/or collectively by the at least one processor, may cause the electronic device to: identify tilt information of the electronic device detected via the sensor module, based on a degree of tilt of the electronic device with respect to a gravitational acceleration direction indicated by the tilt information, display an execution screen of a main task of the electronic device in a first area of the display to be continuously rotatable, and based on identifying a degree of tilt of the electronic device with respect to a reference direction indicated by the tilt information changing by at least a threshold range and/or value, rearrange and display a control element corresponding to the main task in a second area which is at least a portion of the first area at least by rotating and/or relocating the control element according to a screen orientation determined by the tilt information.

### BRIEF DESCRIPTION OF DRAWINGS

FIG. 1 is a block diagram of an electronic device in a network environment according to an example embodiment.

FIG. 2 is a diagram illustrating display areas of an electronic device according to an example embodiment.

FIG. 3 is a flowchart of a display method performed by an electronic device according to an example embodiment.

FIGS. 4a-4d and 5a-5b are diagrams illustrating a method of displaying a control element according to screen orientations according to an example embodiment.

FIGS. 6 and 7a-7d are diagrams illustrating a method of displaying a control element in a user-customized manner according to an example embodiment.

FIGS. 8a-8d, 9a-9c, and 10a-10d are diagrams illustrating a method of displaying a control element according to an example embodiment.

FIGS. 11a-11d, 12a-12b, 13a-13b, and 14 are diagrams illustrating elements displayed in a second area according to an example embodiment.

FIG. 15 is a diagram illustrating a task controller according to an example embodiment.

FIGS. 16a-16d are diagrams illustrating a display method according to an example embodiment.

### DETAILED DESCRIPTION

Hereinafter, various embodiments of the present disclosure will be described with reference to the accompanying drawings. However, this is not intended to limit the present disclosure to specific embodiments, and it should be understood that various modifications, equivalents, and/or alternatives of the embodiments of the present disclosure are included.

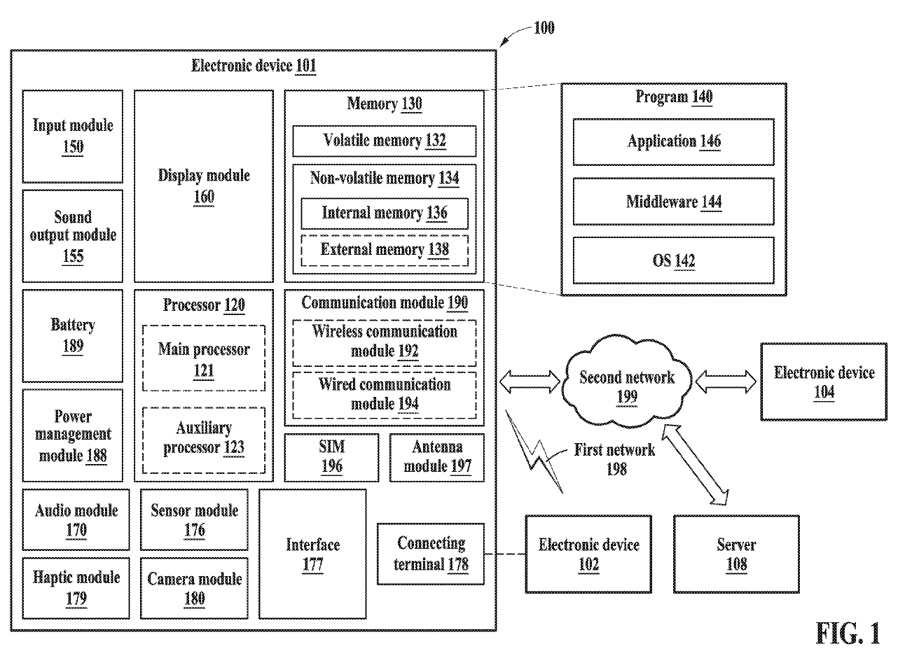

FIG. 1 is a block diagram illustrating an electronic device in a network environment according to an embodiment.

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added to the electronic device 101. In some embodiments, some of the components (e.g., the sensor module 176, the camera module 180, or the antenna module 197) may be integrated into a single component (e.g., the display module 160).

The processor 120, comprising processing circuitry, may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via an external electronic device (e.g., an electronic device 102) (e.g., a speaker or headphone) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected, directly or indirectly, with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, ISPs, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190, comprising communication circuitry, may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as BluetoothTM, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192, comprising communication circuitry, may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a PCB, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled, directly or indirectly, with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-Things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," "coupled to," "connected with," or "connected to" another element (e.g., a second element), it means that the element may be coupled with the other element directly (e.g., wiredly), wirelessly, or via at least a third element(s).

As used in connection with various embodiments of the disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include code generated by a compiler or code executable by an interpreter. The machine-readable storage medium may be provided in the form of a non-transitory storage medium. Wherein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStoreTM), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

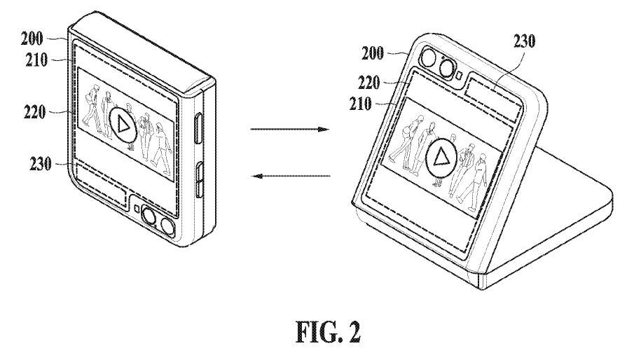

FIG. 2 is a diagram illustrating display areas of an electronic device according to an embodiment.

Referring to FIG. 2, in an embodiment, the electronic device 200 may include a housing and a display 210 (e.g., the display 101 of FIG. 1) disposed in a space formed by the housing. For example, the housing may include a foldable housing. According to an embodiment, a surface on which the display 210 is disposed, directly or indirectly, may be indicated as a first surface of the electronic device 200. In addition, a surface opposite to the first surface may be indicated as a second surface of the electronic device 200. For example, a separate display may be disposed on, directly or indirectly, the second surface.

According to an embodiment, the display 210 may include a first area 220 in which a main task is executed and a second area 230 in which a control element is displayed. The display 210 of the electronic device 200 may have a shape in which a notch area including a camera (e.g., the camera module 180 of FIG. 1) and/or various sensors disposed adjacent to the display 210 or in a portion of the display 210 is cut out.

According to an embodiment, the first area 220 may represent an entire area of the display 210. The second area 230 may represent an area that is at least a portion of the first area 220. In the second area 230, an execution screen of the main task displayed in the first area 220 may be continuously displayed. The electronic device 200 may display the control element by overlaying the control element on the execution screen of the main task in the second area 230.

According to an embodiment, the first area 220 may represent a rectangular area in which the main task is executed on the display 210. For example, the second area 230 may represent a remaining area of the display 210 excluding the first area 220.

According to an embodiment, a screen output on the display 210 may be rotated based on tilt information of the electronic device 200. The tilt information may include at least one of a tilt value (or angle), horizontal state, or rotation direction of the electronic device 200. Referring to FIG. 2, an orientation of the execution screen of the main task in the first area 220 may change based on a state in which at least a portion of the electronic device 200 is folded or placed, a mounted state, or a tilt change due to a user's grip. The electronic device 200 may determine a direction in which the screen is displayed (e.g., a screen orientation) by detecting tilt information of the electronic device 200 through various sensors (e.g., the sensor module 176 of FIG. 1).

According to an embodiment, the electronic device 200 may display the execution screen of the main task in the first area 220 based on a vertical direction (or vertical mode) and a horizontal direction (or horizontal mode). For example, the electronic device 200 may display the execution screen for four screen orientations, including two different directions of vertical mode and two different directions of horizontal mode. When a degree of tilt of the electronic device 200 with respect to a reference direction indicated by the detected tilt information changes by a threshold range, the electronic device 200 may display the execution screen of the main task by rotating the execution screen of the main task according to a new screen orientation determined by the tilt information. According to an embodiment, the reference direction may represent a gravitational acceleration direction. According to an embodiment, the reference direction may represent axis direction(s) set for a specific screen orientation. For example, when the execution screen of the main task rotates from one screen orientation to another screen orientation, the electronic device 200 may continuously display a process of the execution screen orientation being rotated. That is, the electronic device 200 may not only immediately switch the execution screen of the main task from one screen orientation to another screen orientation, but also continuously display the rotation process through an animation of the execution screen of the main task rotating from one screen orientation to another screen orientation.

According to an embodiment, the electronic device 200 may display the execution screen of the main task in the first area 220 based on the gravitational acceleration direction. For example, the electronic device 200 may, based on a degree of tilt of the electronic device 200 with respect to the gravitational acceleration direction indicated by the tilt information, display the execution screen of the main task of the electronic device 200 to be continuously rotatable. “Based on” as used herein covers based at least on.

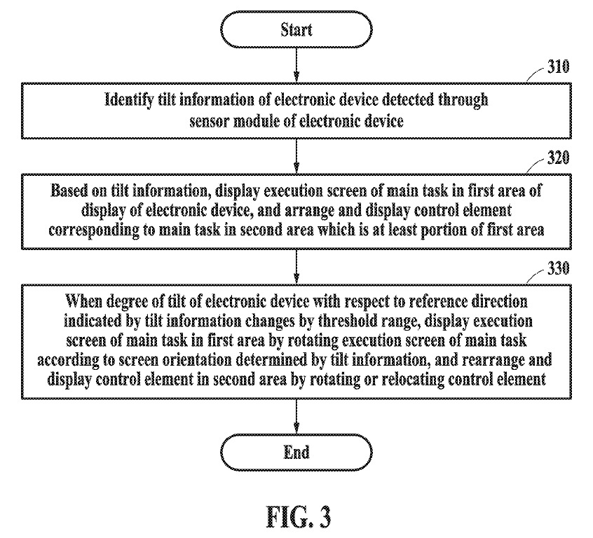

FIG. 3 is a flowchart of a display method performed by an electronic device according to an embodiment.

According to an embodiment, operations 310 to 330 described below may be performed by an electronic device (e.g., the electronic device 101 of FIG. 1 or the electronic device 200 of FIG. 2).

In operation 310, the electronic device may identify tilt information of the electronic device detected through a sensor module (e.g., the sensor module 176 of FIG. 1). The tilt information may include at least one of a tilt value (or angle), horizontal state, or rotation direction of the electronic device.

In operation 320, the electronic device may, based on the tilt information, display an execution screen of a main task in a first area (e.g., the first area 220 of FIG. 2) of a display (e.g., the display 210 of FIG. 2), and arrange and display a control element corresponding to the main task in a second area (e.g., the second area 230 of FIG. 2) which is at least a portion of the first area. Specifically, the electronic device may display the execution screen of the main task in the first area according to a screen orientation determined by the tilt information, and display the control element in the second area according to an arrangement corresponding to the same screen orientation.

According to an embodiment, the electronic device may display a screen based on a vertical direction (or vertical mode) and a horizontal direction (or horizontal mode). For example, the electronic device may display a screen in which the second area is arranged at a bottom of the first area or the second area is arranged at a top of the first area in the vertical direction. For example, the electronic device may display a screen in which the second area is arranged at a left side of the first area or the second area is arranged at a right side of the first area for the horizontal direction.

According to an embodiment, the control element may include at least one of a navigation bar, a keyboard control button, a list of content associated with the main task, a notification associated with another application not associated with the main task, or an output display switching element.

According to an embodiment, the control element may be a navigation bar, and the navigation bar may include at least one of icons representing functions for controlling a plurality of applications executed in the electronic device (e.g., a list of currently running applications, home screen, and cancel (or go back)).

According to an embodiment, the control element may be a keyboard control button, and the keyboard control button may hide or control a keyboard when the keyboard is provided on the display of the electronic device.

According to an embodiment, the control element may be a list of content associated with the main task, and the list of content associated with the main task may include, for example, when the main task is photo or video capture, a list of recent photos or videos in an album. For example, when the main task is music or video playback, the list of content may include a list of playable music or videos.

According to an embodiment, the control element may be a notification related to another application not associated with the main task, and the notification associated with another application not associated with the main task may include notifications set for messages, advertisements, and other applications.

According to an embodiment, the control element may be an output display switching element, and the output display switching element may represent, for example, when the electronic device includes displays respectively disposed on a first surface of a housing and a second surface opposite to the first surface, a button capable of bidirectionally switching a display to output the execution screen of the main task.

According to an embodiment, the electronic device may, in response to a user input of touch and hold on the second area, display a selection menu for the control element (or information to be displayed) in the second area, and switch and display the control element in the second area based on a selected item.

In operation 330, when a degree of tilt of the electronic device with respect to a reference direction indicated by the tilt information changes by a threshold range, the electronic device may display the execution screen of the main task in the first area by rotating the execution screen of the main task according to a screen orientation determined by the tilt information, and rearrange and display the control element in the second area by rotating or relocating the control element.

According to an embodiment, the reference direction may represent a gravitational acceleration direction.

According to an embodiment, the reference direction may represent axis direction(s) set for a specific screen orientation.

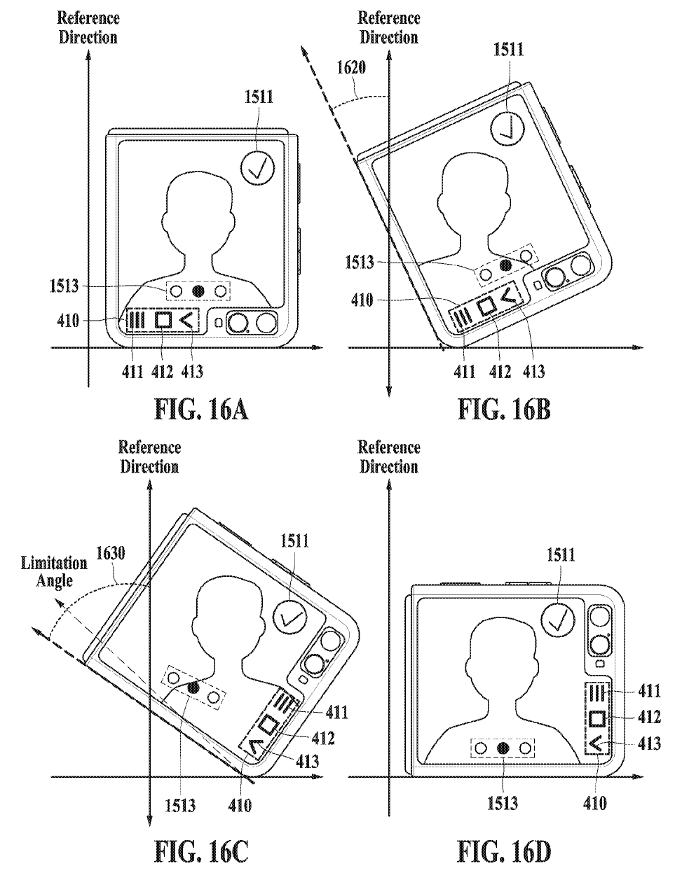

According to an embodiment, a change in the degree of tilt of the electronic device with respect to the reference direction will be described in detail with reference to FIGS. 16a-16d.

According to an embodiment, an arrangement order of the control element may be predetermined for each screen orientation. The electronic device may relocate each individual element, such as icons and buttons, included in the control element according to a predetermined order, according to the changed screen orientation.

According to an embodiment, icons, buttons, or other visual objects constituting the control element may be rearranged by rotating based on the screen orientation of the electronic device.

According to an embodiment, the electronic device may rotate and relocate the control element.

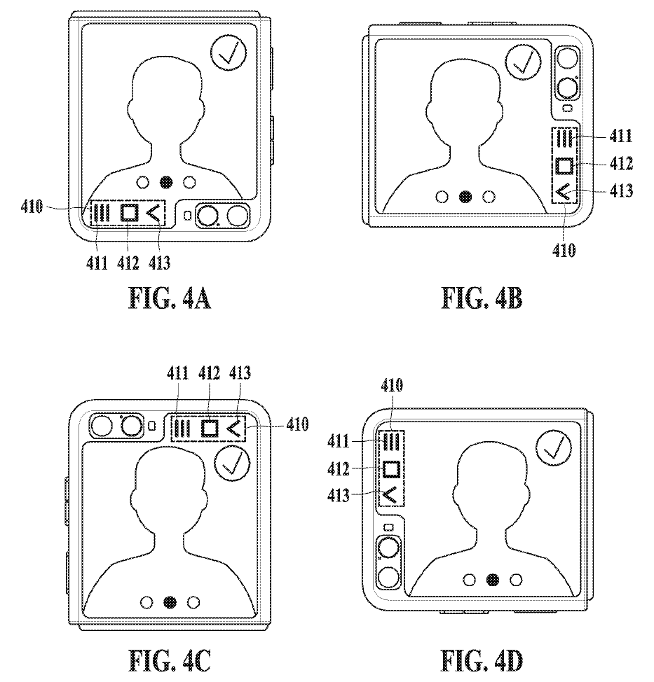

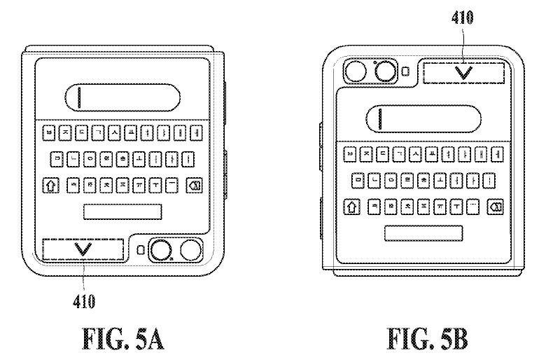

FIGS. 4a-4d and 5a-5d are diagrams illustrating a method of displaying a control element according to a screen orientation, according to an embodiment.

According to an embodiment, an electronic device (e.g., the electronic device 101 of FIG. 1 or the electronic device 200 of FIG. 2) may display a screen based on screen orientations as shown in FIGS. 4a-4d.

Referring to FIGS. 4a-4d, the electronic device may display a control element (e.g., a navigation bar) in a second area 410 (e.g., the second area 230 of FIG. 2) according to an arrangement corresponding to each screen orientation. For example, the navigation bar may include a first icon 411 representing a list of currently running applications, a second icon 412 representing a home screen, and a third icon 413 representing cancel (or go back).

According to an embodiment, for screen orientations corresponding to FIG. 4a and FIG. 4c, the first icon 411, the second icon 412, and the third icon 413 may be sequentially arranged and displayed in a horizontal (left to right) direction.

According to an embodiment, for screen orientations corresponding to FIG. 4b and FIG. 4d, the first icon 411, the second icon 412, and the third icon 413 may be arranged and displayed in a vertical (top to bottom) direction.

According to an embodiment, icons, buttons, or other visual objects constituting the control element may be rearranged by rotating based on the screen orientation of the electronic device. For example, when the screen orientation of the electronic device changes from a screen orientation corresponding to FIG. 4a to a screen orientation corresponding to FIG. 4b, the first icon 411, the second icon 412, and the third icon 413 may rotate according to a rotation direction of the screen orientation and be rearranged from the horizontal direction to the vertical direction.

Referring to FIGS. 5a-5b, the electronic device may display a control element (e.g., a keyboard control button) in the second area 410 according to an arrangement corresponding to each screen orientation. The keyboard control button may hide or control a keyboard when the keyboard is provided on a display (e.g., the display 210 of FIG. 2) of the electronic device. For example, when the screen orientation of the electronic device changes from a screen orientation corresponding to FIG. 5a to a screen orientation corresponding to FIG. 5b, the keyboard control button may be rearranged by rotating according to the screen orientation.

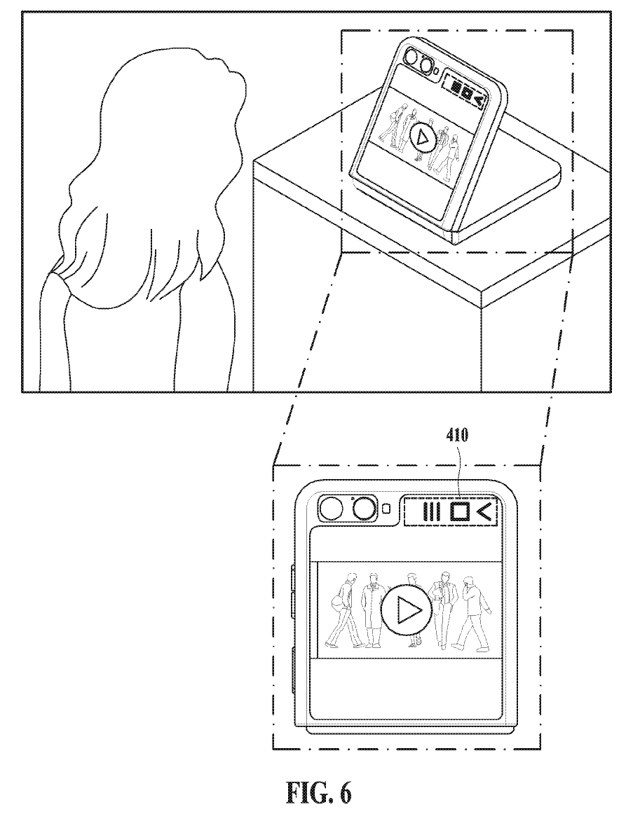

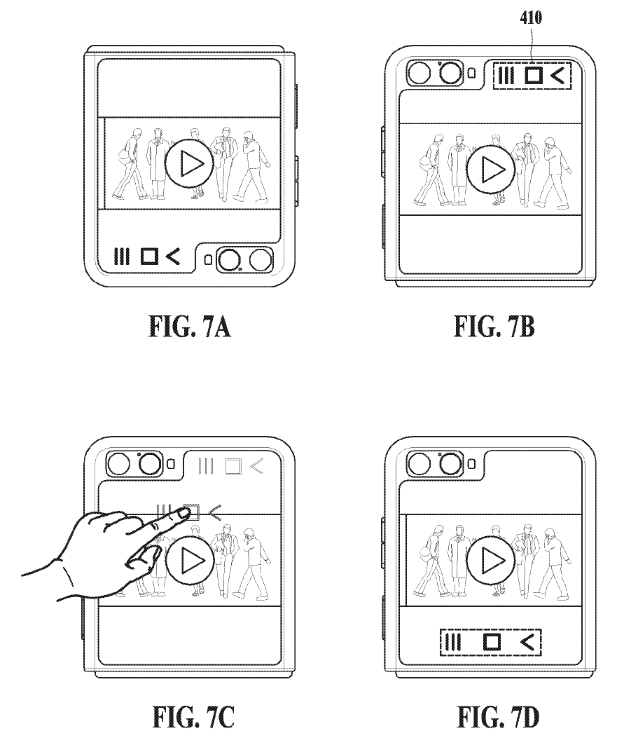

FIGS. 6 and 7 are diagrams illustrating a method of displaying a control element in a user-customized manner according to an embodiment.

According to an embodiment, an electronic device (e.g., the electronic device 101 of FIG. 1 or the electronic device 200 of FIG. 2) may determine a gaze position of a user by analyzing appearance of the user captured by a camera of the electronic device. The electronic device may rearrange and display the control element in the second area 410 based on the gaze position. For example, referring to FIG. 6, when the gaze position of the user is biased toward a right side of the electronic device with respect to the user, the electronic device may rearrange and display the control element by relocating the control element to be biased toward the right side in the second area 410.

According to an embodiment, the electronic device may, in response to a user input of dragging the control element from the second area 410 of the electronic device and dropping the control element to a first area (e.g., the first area 220 of FIG. 2), rearrange and display the control element in the first area. For example, when there is a drag and drop input in a screen orientation where the second area 410 is arranged above the first area as shown in FIG. 7b, the electronic device may rearrange and display the control element by relocating the control element to a lower portion of the first area. Referring to FIG. 7d, for example, spacing between icons, buttons, or other visual objects constituting the control element may be rearranged to be widened.

According to an embodiment, the electronic device may, in response to a user input of dragging the control element displayed in the first area and dropping the control element to the second area 410, rearrange and display the control element in the second area.

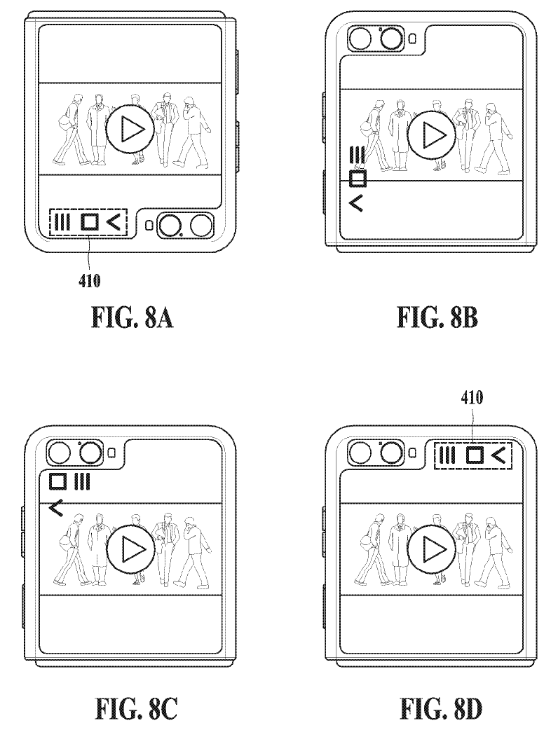

FIGS. 8 to 10 are diagrams illustrating a method of displaying a control element according to an embodiment.

According to an embodiment, when an electronic device (e.g., the electronic device 101 of FIG. 1 or the electronic device 200 of FIG. 2) rearranges and displays a control element due to a screen orientation changing from one screen orientation to another screen orientation, the electronic device may continuously display a trajectory along which the control element is rearranged.

Referring to FIGS. 8a-8d, when the screen orientation of the electronic device changes from a screen orientation corresponding to FIG. 8a to screen orientations corresponding to FIGS. 8b to 8d, the control element in the second area 410 may be rearranged and displayed based on the changed screen orientation as shown in FIG. 8d. The electronic device may continuously display a trajectory along which the control element is rearranged as shown in FIG. 8b and FIG. 8c. Therefore, the user may easily recognize changed positions and order of the configuration of the control element.

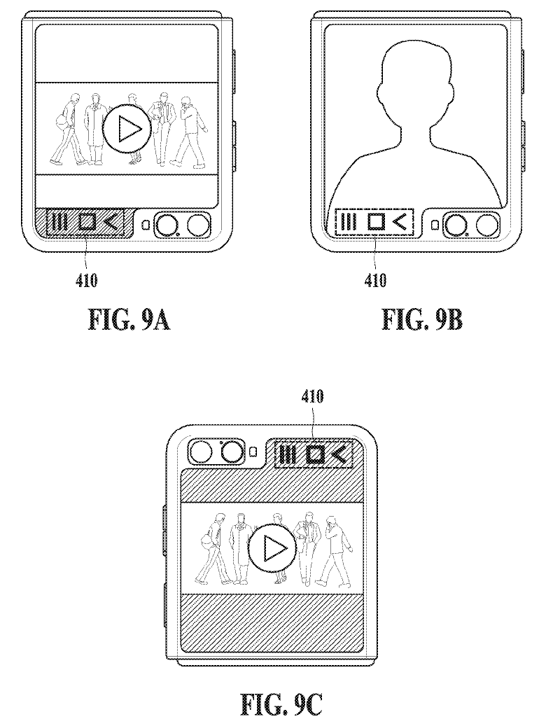

According to an embodiment, the electronic device may display the control element in the second area 410 in various ways. Referring to FIG. 9a, the electronic device may display a background color of the second area darkly so that the second area 410 is clearly distinguished from a first area (e.g., the first area 220 of FIG. 2). Alternatively, the electronic device may extract a main screen color of the first area and apply the extracted color to a background color of the second area 410 for display.

According to an embodiment, referring to FIG. 9b, when a main task executed in the first area is of a target type, the electronic device may extend and display the execution screen of the main task in the second area 410. The electronic device may display the control element in the second area 410 by overlaying the control element on the execution screen of the main task. For example, when the main task executed in the first area relates to camera capture, such as video recording or video calling, a screen of captured video may be extended to the second area 410, and the control element may be overlaid.

According to an embodiment, referring to FIG. 9c, when a screen color executed in the first area is detected to be similar to a background color of the second area 410, the electronic device may display borders of icons or buttons of the control element thickly or in a color opposite to the background color so that the control element is distinguished from the screen color.

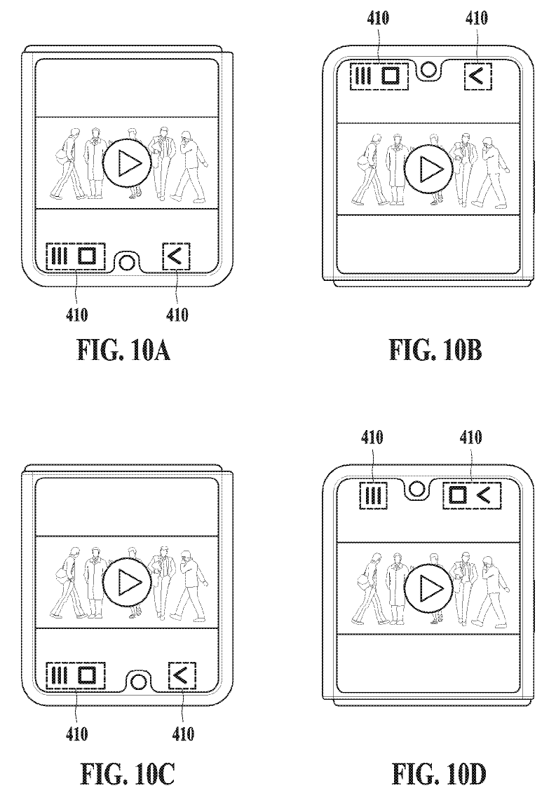

According to an embodiment, the electronic device may display the control element as divided according to a shape of the second area 410. A notch, including a camera, of the electronic device may be disposed at a middle position of the display as shown in FIG. 10a and FIG. 10b or at a position biased in one direction as shown in FIG. 10c and FIG. 10d, and the position of the notch is not limited to the present disclosure. The electronic device may divide configurations of the control element based on divided spacing of the second area 410 divided by the notch, size of the notch, and the like, and rearrange the control element by adjusting spacing.

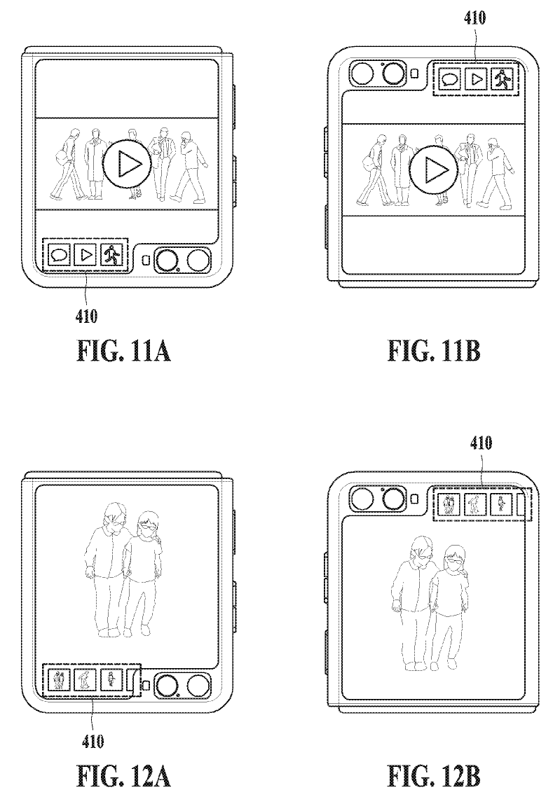

FIGS. 11a to 14 are diagrams illustrating elements displayed in a second area according to an embodiment.

According to an embodiment, referring to FIGS. 11a-11d, an electronic device may display a list of currently running applications in a second area 410 (e.g., the second area 230 of FIG. 2) according to an arrangement corresponding to each screen orientation. For example, in response to a user input on an icon representing "the list of currently running applications" of the navigation bar described with reference to FIGS. 4a-4d, the electronic device may display a list of one or more currently running applications. The user may check previews of various applications by scrolling the list and execute a specific application.

According to an embodiment, referring to FIG. 12a and FIG. 12b, the electronic device may display a list of content associated with the main task in the second area 410 according to an arrangement corresponding to each screen orientation. For example, when the main task is photo or video capture, the list of content may include a list of recent photos or videos in an album. Such a list may be exposed in thumbnail format. For example, when the main task is music or video playback, the list of content may include a list of playable music or videos. The user may check previews of various content by scrolling the list and selecting specific content.

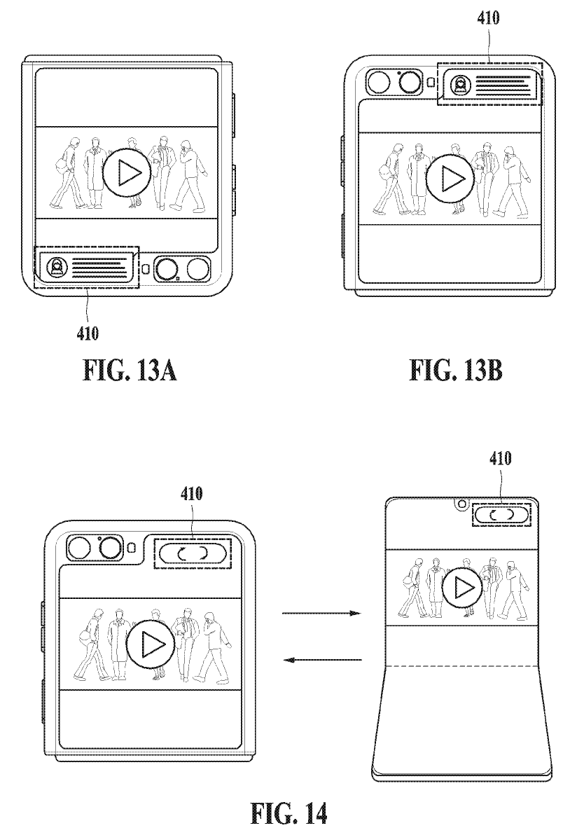

According to an embodiment, referring to FIG. 13a and FIG. 13b, the electronic device may output a notification associated with another application not associated with the main task in the second area 410. For example, the notification may be overlaid on a control element already displayed in the second area 410 and output for a predetermined time. The notification may include notifications set for messages, advertisements, and other applications.

According to an embodiment, when a screen is displayed based on a horizontal direction of the electronic device, not shown in FIG. 13a and FIG. 13b, the electronic device may output the notification in the same area as the vertical direction, but may show only a part of the configuration of the notification. For example, when a message is output, the notification may include only a sender's profile picture or a type of message application.

According to an embodiment, referring to FIG. 14, the electronic device may display an output display switching element in the second area 410. The output display switching element may represent, for example, when the electronic device includes displays respectively disposed on a first surface of a housing and a second surface opposite to the first surface, a button capable of bidirectionally switching a display to output the execution screen of the main task. The electronic device may display the output display switching element in the second area 410 when it is necessary to switch the output display (e.g., when the electronic device is unfolded beyond a predetermined angle). The electronic device may switch a screen on which the main task is executed to another display in response to a user input on the output display switching element.

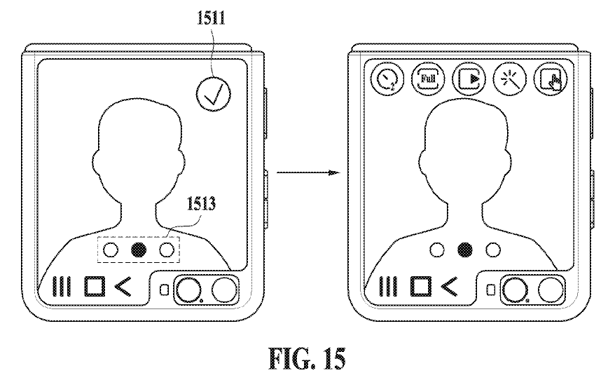

FIG. 15 is a diagram illustrating a task controller according to an embodiment.

According to an embodiment, an electronic device (e.g., the electronic device 101 of FIG. 1 or the electronic device 200 of FIG. 2) may display a task controller in a first area (e.g., the first area 220 of FIG. 2). The task controller may be displayed as overlaid on an execution screen of a main task in the first area. The task controller may include one or more task controller elements. For example, the task controller may include a first element 1511 and a second element 1513. For example, the first element 1511 may be displayed at an upper right of the first area, and the second element 1513 may be displayed at a bottom of the first area, but is not limited to the described embodiment.

According to an embodiment, an expanded task controller element may be displayed by a touch input on the first element 1511. The expanded task controller element may include various control buttons corresponding to the main task being executed in the first area. A mode of the main task being executed in the first area may be changed by a touch input or swipe on the second element 1513. For example, when an execution screen of a camera widget is displayed in the first area, various shooting setting menus may be displayed when the user touches the first element 1511, and a shooting mode such as portrait photography or video shooting may be selected through the second element 1513.

FIGS. 16a-16d are diagrams illustrating a display method according to an embodiment.

According to an embodiment, an electronic device (e.g., the electronic device 101 of FIG. 1 or the electronic device 200 of FIG. 2) may display an execution screen of a main task in a first area (e.g., the first area 220 of FIG. 2) based on a gravitational acceleration direction. According to an embodiment, a reference direction may represent a gravitational acceleration direction. According to an embodiment, the reference direction may represent axis direction(s) set for a specific screen orientation. For example, the reference direction may represent two axis directions set to be orthogonal to each other for a specific screen orientation. The electronic device may display a screen based on screen orientations as shown in FIGS. 16a-16d.

According to an embodiment, the electronic device may display a task controller corresponding to the main task in the first area based on a screen orientation determined by tilt information of the electronic device. The task controller may be displayed as overlaid on the execution screen of the main task in the first area. For example, the task controller may include a first element 1511 and a second element 1513.

According to an embodiment, the electronic device may display a control element corresponding to the main task in a second area 410 (e.g., the second area 230 of FIG. 2) according to an arrangement corresponding to a screen orientation determined by the tilt information of the electronic device. When a degree of tilt of the electronic device with respect to the reference direction indicated by the tilt information changes by a threshold range, the electronic device may rearrange and display the control element in the second area by rotating or relocating the control element according to a screen orientation determined by the tilt information. According to an embodiment, for a screen orientation corresponding to FIG. 16a, a first icon 411, a second icon 412, and a third icon 413 may be sequentially arranged and displayed in a horizontal (left to right) direction. According to an embodiment, for a screen orientation corresponding to FIG. 16d, the first icon 411, the second icon 412, and the third icon 413 may be arranged and displayed in a vertical (top to bottom) direction.

According to an embodiment, for screen orientations corresponding to FIG. 16a and FIG. 16d, the first element 1511 may be displayed at an upper right of the first area, and the second element 1513 may be displayed at a bottom of the first area. Since the position of the task controller changes according to changes in screen orientation, a screen with the task controller displayed at the same position may be provided to the user.

According to an embodiment, while the control element is displayed according to a first screen orientation (e.g., the screen orientation corresponding to FIG. 16a, when a degree of tilt of the electronic device with respect to the reference direction changes by a threshold range (e.g., 70° to 140°), the electronic device may rearrange and display the control element based on a second screen orientation (e.g., the screen orientation corresponding to FIG. 16d. According to an embodiment, while the task controller is displayed according to the first screen orientation, when a degree of tilt of the electronic device with respect to the reference direction changes by the threshold range, the electronic device may display the task controller at a position corresponding to the second screen orientation. For example, the degree of tilt of the electronic device with respect to the reference direction may represent an angle value between the reference direction and a vertical direction corresponding to a screen orientation of the electronic device. The electronic device may consider tilt direction or amount of tilt change together when determining the screen orientation by the tilt information. The electronic device may store a tilt range or limitation angle (e.g., 70°) of the electronic device relative to a reference direction that maintains a specific screen orientation. Referring to FIG. 16b, since a tilt value 1620 of the electronic device is less than the limitation angle, the control element may not be rearranged, or the position of the task controller may not be changed. Referring to FIG. 16c, since a tilt value 1630 of the electronic device belongs to the threshold range, the control element may be rearranged, and the position of the task controller may be changed.

An electronic device 101; 200, according to an embodiment, may include: a display 210; a sensor module 176; at least one processor 120 comprising processing circuitry; and a memory 130 storing instructions, wherein the instructions, when executed individually or collectively by the at least one processor 120, cause the electronic device 101; 200 to: identify tilt information of at least part of the electronic device 101; 200 detected through the sensor module 176, based on the tilt information, display an execution screen of a main task in a first area 220 of the display 210, and display a control element corresponding to the main task in a second area 230; 410 which is at least a portion of the first area 220, and based on identifying a degree of tilt of at least part of the electronic device 101; 200 with respect to a reference direction indicated by the tilt information changing by at least a threshold range and/or amount, display the execution screen of the main task in the first area 220 at least by rotating the execution screen of the main task according to a screen orientation determined based on the tilt information, and rearrange and display the control element in the second area 230; 410 at least by rotating or relocating the control element.

The control element, according to an embodiment, may include a navigation bar.

The control element, according to an embodiment, may include a keyboard control button.

The control element, according to an embodiment, may include a list of content associated with the main task.

According to an embodiment, the instructions, when executed individually or collectively by the at least one processor 120, may cause the electronic device 100; 200 to: output a notification associated with another application not associated with the main task to the second area 230; 410.

The control element, according to an embodiment, may include an output display switching element.

According to an embodiment, the instructions, when executed individually or collectively by the at least one processor 120, may cause the electronic device 100; 200 to: determine a gaze position of a user at least by analyzing appearance of the user captured by a camera of the electronic device 101; 200, and rearrange and display the control element based on the gaze position.

According to an embodiment, the instructions, when executed individually or collectively by the at least one processor 120, may cause the electronic device 100; 200 to: in response to a user input comprising dragging the control element from the second area 230; 410 and dropping the control element to the first area 220, rearrange and display the control element in the first area 220.

According to an embodiment, the instructions, when executed individually or collectively by the at least one processor 120, may cause the electronic device 100; 200 to: when rearranging and displaying the control element based on the screen orientation determined based on the tilt information, continuously display a trajectory along which the control element is rearranged.

According to an embodiment, the instructions, when executed individually or collectively by the at least one processor 120, may cause the electronic device 100; 200 to: when the main task executed in the first area 220 is of a target type, extend and display the execution screen of the main task in the second area 230; 410, and display the control element by overlaying the control element on the execution screen of the main task.

The control element, according to an embodiment, may be displayed as divided according to a shape of the second area 230; 410.

A display method, according to an embodiment, performed by an electronic device 101; 200 may include: identifying tilt information of the electronic device 101; 200 detected via a sensor of the electronic device 101; 200; based on the tilt information, displaying an execution screen of a main task in a first area 220 of a display 210 of the electronic device 101; 200, and arranging and/or displaying a control element corresponding to the main task in a second area 230; 410 which is at least a portion of the first area 220; and based on identifying a degree of tilt of the electronic device 101; 200 with respect to a reference direction indicated by the tilt information changing by at least a threshold range and/or amount, displaying the execution screen of the main task in the first area 220 at least by rotating the execution screen of the main task based on a screen orientation determined based on the tilt information, and rearranging and displaying the control element in the second area 230; 410 at least by rotating or relocating the control element.

An electronic device 101; 200, according to an embodiment, may include: a display 210, a sensor module 176 comprising at least one sensor; at least one processor 120 comprising processing circuitry; and a memory 130 storing instructions, wherein the instructions, when executed individually or collectively by the at least one processor 120, may cause the electronic device 101; 200 to: identify tilt information of the electronic device 101; 200 detected via the sensor module 176, based on a degree of tilt of the electronic device 101; 200 with respect to a gravitational acceleration direction indicated by the tilt information, display an execution screen of a main task of the electronic device 101; 200 in a first area 220 of the display 210 to be continuously rotatable, and based on identifying a degree of tilt of the electronic device 101; 200 with respect to a reference direction indicated by the tilt information changing by at least a threshold range and/or value, rearrange and display a control element corresponding to the main task in the second area 230; 410 which is at least a portion of the first area 220 at least by rotating and/or relocating the control element according to a screen orientation determined by the tilt information.

According to an embodiment, the instructions, when executed individually or collectively by the at least one processor 120, may cause the electronic device 100; 200 to: display, in the first area 220, a task controller corresponding to the main task based on the screen orientation determined based on the tilt information, wherein the task controller comprises one or more task controller elements.

According to an embodiment, the instructions, when executed individually or collectively by the at least one processor 120, may cause the electronic device 100; 200 to: based on identifying the degree of tilt of the electronic device 101; 200 with respect to the reference direction indicated by the tilt information changing by at least the threshold range and/or value, display the task controller at a position corresponding to the screen orientation determined based on the tilt information.

The task controller, according to an embodiment, may include one or more task controller elements.

The reference direction, according to an embodiment, may represent an axis direction set for each screen orientation.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, a field-programmable gate array (FPGA), a programmable logic unit (PLU), a microprocessor or any other device capable of responding to and executing instructions in a defined manner. The processing device may run an operating system (OS) and software applications that run on the OS. The processing device also may access, store, manipulate, process, and create data in response to execution of the software. For purpose of simplicity, the description of a processing device is singular; however, one of ordinary skill in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or one or more combinations thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording media.

The methods according to the examples described herein may be recorded in non-transitory computer-readable media including program instructions to implement various operations of the examples. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), RAM, flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

As described above, although the embodiments have been described with reference to the limited drawings, one of ordinary skill in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other example embodiments, and equivalents to the claims are also within the scope of the following claims.

1. An electronic device, comprising:
a display;
a sensor module;
at least one processor comprising processing circuitry; and
a memory storing instructions,
wherein the instructions, when executed individually and/or collectively by the at least one processor, cause the electronic device to:
identify tilt information of at least part of the electronic device detected through the sensor module,
based on the tilt information, display an execution screen of a main task in a first area of the display, and display a control element corresponding to the main task in a second area which is at least a portion of the first area, and
based on identifying a degree of tilt of at least part of the electronic device with respect to a reference direction indicated by the tilt information changing by at least a threshold range and/or amount, display the execution screen of the main task in the first area at least by rotating the execution screen of the main task according to a screen orientation determined based on the tilt information, and rearrange and display the control element in the second area at least by rotating and/or relocating the control element.

2. The electronic device of claim 1,
wherein the control element comprises a navigation bar.

3. The electronic device of claim 1,
wherein the control element comprises a keyboard control button.

4. The electronic device of claim 1,
wherein the control element comprises a list of content associated with the main task.

5. The electronic device of claim 1,
wherein the instructions, when executed individually and/or collectively by the at least one processor, cause the electronic device to:
output a notification associated with another application not associated with the main task to the second area.

6. The electronic device of claim 1,
wherein the control element comprises an output display switching element.

7. The electronic device of claim 1,
wherein the instructions, when executed individually and/or collectively by the at least one processor, cause the electronic device to:
determine a gaze position of a user at least by analyzing appearance of the user captured by a camera of the electronic device, and
rearrange and display the control element based on the gaze position.

8. The electronic device of claim 1,
wherein the instructions, when executed individually and/or collectively by the at least one processor, cause the electronic device to:
in response to a user input comprising dragging the control element from the second area and dropping the control element to the first area, rearrange and display the control element in the first area.

9. The electronic device of claim 1,
wherein the instructions, when executed individually and/or collectively by the at least one processor, cause the electronic device to:
when rearranging and displaying the control element based on the screen orientation determined based on the tilt information, continuously display a trajectory along which the control element is rearranged.

10. The electronic device of claim 1,
wherein the instructions, when executed individually and/or collectively by the at least one processor, cause the electronic device to:
when the main task executed in the first area is of a target type, extend and display the execution screen of the main task in the second area, and display the control element by overlaying the control element on the execution screen of the main task.

11. The electronic device of claim 1,
wherein the control element is displayed as divided according to a shape of the second area.

12. A display method performed by an electronic device, the display method comprising:
identifying tilt information of the electronic device detected via a sensor of the electronic device;
based on the tilt information, displaying an execution screen of a main task in a first area of a display of the electronic device, and arranging and/or displaying a control element corresponding to the main task in a second area which is at least a portion of the first area; and
based on identifying a degree of tilt of the electronic device with respect to a reference direction indicated by the tilt information changing by at least a threshold range and/or amount, displaying the execution screen of the main task in the first area at least by rotating the execution screen of the main task based on a screen orientation determined based on the tilt information, and rearranging and displaying the control element in the second area at least by rotating or relocating the control element.

13. An electronic device, comprising:
a display;
a sensor module comprising at least one sensor;
at least one processor comprising processing circuitry; and
a memory storing instructions,
wherein the instructions, when executed individually and/or collectively by the at least one processor, cause the electronic device to:
identify tilt information of the electronic device detected via the sensor module,
based on a degree of tilt of the electronic device with respect to a gravitational acceleration direction indicated by the tilt information, display an execution screen of a main task of the electronic device in a first area of the display to be continuously rotatable, and,
based on identifying a degree of tilt of the electronic device with respect to a reference direction indicated by the tilt information changing by at least a threshold range and/or value, rearrange and display a control element corresponding to the main task in a second area which is at least a portion of the first area at least by rotating and/or relocating the control element according to a screen orientation determined by the tilt information.

14. The electronic device of claim 13,
wherein the instructions, when executed individually and/or collectively by the at least one processor, cause the electronic device to:
display, in the first area, a task controller corresponding to the main task based on the screen orientation determined based on the tilt information,
wherein the task controller comprises one or more task controller elements.

15. The electronic device of claim 13,
wherein the instructions, when executed individually and/or collectively by the at least one processor, cause the electronic device to:
based on identifying the degree of tilt of the electronic device with respect to the reference direction indicated by the tilt information changing by at least the threshold range and/or value, display the task controller at a position corresponding to the screen orientation determined based on the tilt information.
